(19) United States
(12) Patent Application Publication
(10) Pub. No.: US 2024/0171415 A1
(43) Pub. Date: May 23, 2024

(54) POWER OVER ETHERNET SYSTEM AND SWITCHING DEVICE AND METHOD FOR THE SAME

(71) Applicant: SENAO NETWORKS,INC., Taipei (TW)

(72) Inventor: Pi-Kung KU, Taipei (TW)

(21) Appl. No.: 18/424,961

(22) Filed: Jan. 29, 2024

(30) Foreign Application Priority Data
Oct. 17, 2013 (TW) 112139679

(51) Int. Cl. H04L 12/10; G06F 1/26

(52) U.S. Cl. CPC H04L 12/10; G06F 1/266

(57) ABSTRACT

A Power over Ethernet (PoE) system includes a plurality of PoE ports, a power detector, a plurality of switches, at least one DC converter module and a controller. The power detector can detect the power input from each of the PoE ports and accordingly generate a detection signal. The controller can generate a control signal according to the detection signal, and the control signal is used to control the switches in order to control the electrical connections between the PoE ports and the at least one DC converter module.

### CROSS-REFERENCE TO RELATED APPLICATIONS

This application claims priority to Taiwan Patent Application No. 112139679 filed on Oct. 17, 2023, which is hereby incorporated by reference in its entirety.

### BACKGROUND OF THE INVENTION

### Field of the Invention

The present invention relates to a power supply system, and a power supply switching device and a power supply switching method for the same. More specifically, the present invention relates to a Power over Ethernet (POE) system, and a POE switching device and a POE switching method for the same.

### Descriptions of the Related Art

A traditional power over network system, which is also known as a POE system, comprises one or more power supplying channels, and each of the power supplying channels comprises a POE port and a corresponding direct current (DC) converter module. Because each POE port is fixedly used in combination with one DC converter module, when a certain POE port itself is abnormal or the power input from the certain POE port is abnormal, the DC converter module used in combination with the POE port may not be used effectively, which leads to the reduction of the power supplying capacity of the POE system. Accordingly, an urgent need exists in the art to improve the above problems of the traditional POE system.

### SUMMARY OF THE INVENTION

To overcome at least the aforesaid problems, an embodiment of the present invention provides a Power over Ethernet (POE) system. The POE system may comprise a plurality of POE ports, a power detector, a plurality of switches, at least one direct current (DC) converter module and a controller. The power detector may be connected with the plurality of POE ports and configured to detect a power input from each of the plurality of POE ports and generate a detection signal. The plurality of switches may be connected with the plurality of POE ports respectively, and the at least one DC converter module may be connected with the plurality of switches. The controller may be connected with the power detector and the plurality of switches, and configured to generate a control signal based on the detection signal, wherein the control signal is used to control the plurality of switches and thus controls electrical connections between the plurality of POE ports and the at least one DC converter module.

To overcome at least the aforesaid problems, an embodiment of the present invention further provides a POE switching device for a POE system. The POE switching device may comprise a power detector, a plurality of switches and a controller. The power detector may be connected with a plurality of POE ports, and configured to detect a power input from each of the plurality of POE ports and generate a detection signal. The plurality of switches may be connected with the plurality of POE ports respectively and connected with at least one DC converter module. The controller may be connected with the power detector and the plurality of switches, and configured to generate a control signal based on the detection signal, wherein the control signal is used to control the plurality of switches and thus controls electrical connections between the plurality of POE ports and the at least one DC converter module.

To overcome at least the aforesaid problems, an embodiment of the present invention further provides a POE switching method for a POE system. The POE switching method comprises the following steps: detecting a power input from each of a plurality of POE ports and generate a detection signal by a power detector; and generating a control signal by a controller based on the detection signal, wherein the control signal is used to control a plurality of switches and thus controls electrical connections between the plurality of POE ports and at least one DC converter module, and wherein the plurality of switches are connected with the plurality of POE ports respectively and connected with the at least one DC converter module.

As described above, the present invention can monitor the input state of each of the POE ports in real time through the power detector, and by means of a plurality of switches arranged between the POE ports and the DC converter module, the present invention can determine the electrical connections between the POE ports and the DC converter module according to the input state of the POE ports. For example, when it is detected by the present invention that a certain POE port itself is abnormal or the power input from the certain POE port is abnormal, the present invention can interrupt the electrical connection between the abnormal POE port and the DC converter module connected thereto by controlling the corresponding switch, and initiate the electrical connection between another POE port (non-abnormal POE port) and the DC converter module by controlling the corresponding switch. Therefore, the present invention can effectively solve the above problems.

What has described above is not intended to limit the present invention, but merely outlines the solvable technical problems, the usable technical means, and the achievable technical effects for a person having ordinary skill in the art to preliminarily understand the present invention. According to the attached drawings and the following detailed description, a person having ordinary skill in the art can further understand the details of various embodiments of the present invention.

### BRIEF DESCRIPTION OF THE DRAWINGS

FIG. 1 illustrates a schematic view of a structure of a POE system according to some embodiments of the present invention.

FIG. 2 illustrates a schematic view of a structure of a POE system according to some other embodiments of the present invention.

FIG. 3 illustrates a flowchart for describing a POE switching method according to some embodiments of the present invention.

### DESCRIPTION OF THE PREFERRED EMBODIMENT

The embodiments as disclosed below are not intended to limit the claimed invention to any specific environment, applications, structures, processes or situations. Elements unrelated to the present invention are omitted from depiction, but may be implied in the attached drawings. In the attached drawings, dimensions of and dimensional scales among individual elements are provided only for illustration, and are not intended to limit the present invention. Unless otherwise specified, in the following description, the same (or similar) reference numerals may correspond to the same (or similar) elements. Unless otherwise specified, the number of respective elements described below may be one or more while being implementable.

The terminology used herein is for the purpose of describing the embodiments only and is not intended to limit the present invention. Unless clearly indicated otherwise in the context, the singular form “a/an/one” is intended to include the plural form as well. Terms such as “including” and “comprising” indicate the presence of features, integers, steps, operations, elements and/or components described herein, but do not exclude the presence of one or more other features, integers, steps, operations, elements, components and/or combinations thereof. The term “and/or” includes any and all combinations of one or more related items listed.

Unless otherwise stated in the context, descriptors such as “first”, “second” and “third” are only used to distinguish the elements preceded by the descriptors, and such descriptors should not be construed as indicating the sequence.

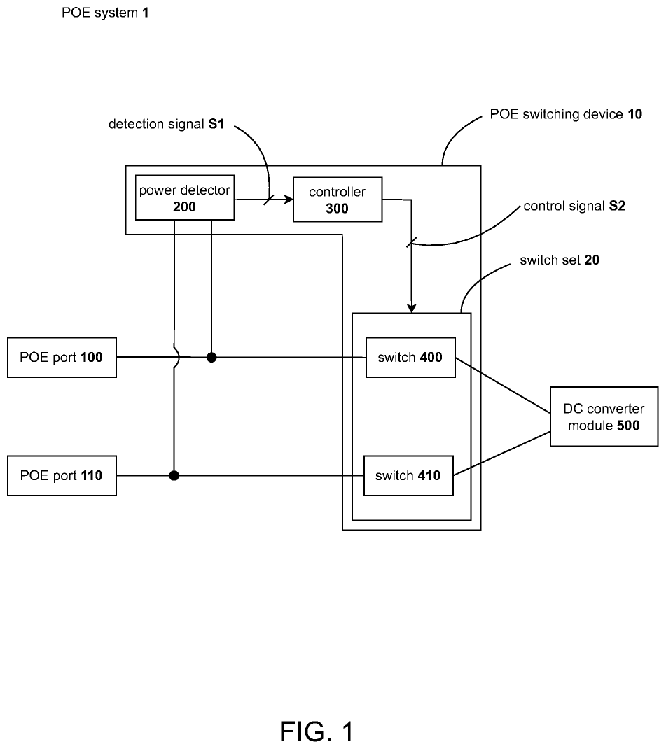

FIG. 1 illustrates a schematic view of a POE system according to some embodiments of the present invention. The content shown in FIG. 1 is provided only for illustrating some embodiments of the POE system, and is not construed as any limitations in the present invention.

Referring to FIG. 1, in some embodiments of the present invention, a POE system 1 may basically comprise a plurality of POE ports (e.g., POE ports 100 and 110), a POE switching device 10 and a DC converter module 500. The POE switching device 10 may basically comprise a power detector 200, a controller 300 and a switch set 20, wherein the switch set 20 may include a plurality of switches (e.g., switches 400 and 410). The power detector 200 may be connected with each of the plurality of POE ports (e.g., the POE ports 100 and 110), and the plurality of switches (e.g., the switches 400 and 410) may be connected with the plurality of POE ports (e.g., the POE ports 100 and 110) respectively and connected with the DC converter module 500. The controller 300 is also connected with the power detector 200 and each switch in the switch set 20.

When the POE system 1 is in operation, the power detector 200 may be used to detect the power input from each of the plurality of POE ports (e.g., the POE ports 100 and 110), and after detecting the power supplying conditions of respective POE ports, the power detector 200 generates and provides a detection signal S1 for the controller 300. The controller 300 may be used to generate a control signal S2 according to the detection signal S1, and control the operation of the plurality of switches (e.g., the switches 400 and 410) in the switch set 20 by the control signal S2, thereby controlling the electrical connections between the plurality of POE ports (e.g., the POE ports 100 and 110) and the DC converter module 500.

The detection signal S1 may be used to indicate an input state of each of the plurality of POE ports (e.g., the POE ports 100 and 110). For example, the detection signal S1 may indicate different input states in respond to various current conditions of the POE port 100 (for example but not limited to: performing power supplying, not performing power supplying, being plugged in, being unplugged, POE port damaged, quality of power input, etc.) so that the controller 300 can obtain the input state of each of the plurality of POE ports (e.g., the POE ports 100, 110) in real time.

For example, in FIG. 1, the controller 300 may determine which of the POE ports 100 and 110 is suitable for establishing electrical connection with the DC converter module 500 according to the detection signal S1, and then control the switches 400 and 410 through the control signal S2 so that the POE port determined as suitable can transmit the input power thereof to the DC converter module 500. Then, the power converted by the DC converter module 500 can be provided to various powered devices for use.

In some embodiments, if the controller 300 determines that none of the plurality of POE ports (e.g., the POE ports 100 and 110) is suitable for establishing electrical connection with the DC converter module 500 according to the detection signal S1, then the controller 300 may also control the plurality of switches (e.g., the switches 400 and 410) through the control signal S2 so that none of the plurality of POE ports (e.g., the POE ports 100 and 110) is electrically connected with the DC converter module 500, thereby stopping outputting power to the powered devices.

In some embodiments, when the detection signal S1 indicates that one of the plurality of POE ports (e.g., the POE ports 100 and 110) being electrically connected with the DC converter module 500 is abnormal or the power input from one of the plurality of POE ports is abnormal, the controller 300 may also control the switches 400 and 410 through the control signal S2 to enable another POE port among the plurality of POE ports which is not supplying power to be electrically connected with the DC converter module 500 instead of the abnormal POE port. Taking FIG. 1 as an example, it is assumed that the POE port 100 was originally electrically connected to the DC converter module 500, but when the detection signal S1 indicates that the POE port 100 is abnormal, the controller 300 may control the switches 400 and 410 through the control signal S2 to interrupt the electrical connection between the POE port 100 and the DC converter module 500, and initiate the electrical connection between the POE port 110 and the DC converter module 500 so that the POE port 110 supplies power to the powered devices instead.

In some embodiments, the controller 300 may be further configured to regularly or irregularly switch the electrical connections between the plurality of POE ports (e.g., the POE ports 100 and 110) and the DC converter module 500 in order through the control signal S2. In a case of regular switching, the user may also upload the preset switching time and switching mode to the cloud through a Universal Asynchronous Receiver/Transmitter (UART), and the controller 300 may regularly turn on the switches 400 and 410 in turn according to the preset switching time and switching mode, so that the POE ports 100 and 110 can regularly establish electrical connection with the DC converter module 500 in turn.

In some embodiments, the controller 300 may also be configured to regularly or irregularly switch the electrical connections between the plurality of POE ports (e.g., the POE ports 100 and 110) and the DC converter module 500 at random through the control signal S2. In a case of regular switching, the user may also upload the preset switching time and switching mode to the cloud through a UART, and the controller 300 may regularly turn on the switches 400 and 410 at random according to the preset switching time and switching mode, so that the POE ports 100 and 110 can regularly establish electrical connection with the DC converter module 500 at random.

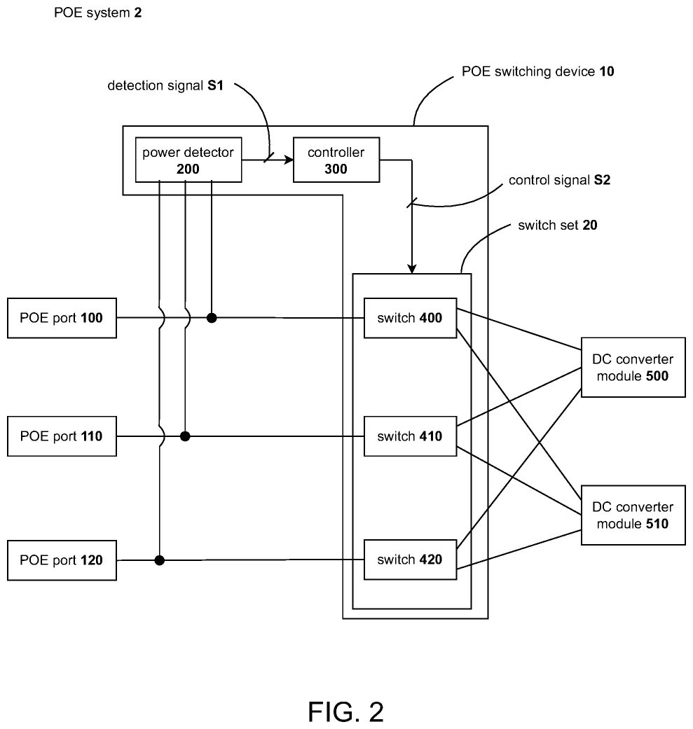

FIG. 2 illustrates a schematic view of a structure of a POE system according to some embodiments of the present invention. The content shown in FIG. 2 is provided only for illustrating some embodiments of the POE system, and is not construed as any limitations in the present invention.

Referring to FIG. 2, in some embodiments of the present invention, a POE system 2 may basically comprise a plurality of POE ports (e.g., POE ports 100, 110 and 120), a POE switching device 10, and a plurality of DC converter modules (e.g., DC converter modules 500 and 510). The POE switching device 10 in FIG. 2 may basically comprise a power detector 200, a controller 300 and a switch set 20, and the switch set 20 may include a plurality of switches (e.g., switches 400, 410 and 420). The power detector 200 may be connected with each of the plurality of POE ports (e.g., the POE ports 100, 110 and 120). The plurality of switches (e.g., the switches 400, 410 and 420) may be connected with the plurality of POE ports (e.g., the POE ports 100, 110, 120) respectively and connected with each of the plurality of DC converter modules (e.g., the DC converter modules 500 and 510). The controller 300 may be also connected with the power detector 200 and each switch in the switch set 20.

When the POE system 2 is in operation, the power detector 200 may be used to detect the power input from each of the plurality of POE ports (e.g., the POE ports 100, 110 and 120), and after detecting the power supplying conditions of respective POE ports, the power detector 200 generates and provides a detection signal S1 similar to that shown in FIG. 1 for the controller 300. The controller 300 may be used to generate a control signal S2 according to the detection signal S1, and control the operation of the plurality of switches (e.g., the switches 400, 410 and 420) in the switch set 20 by the control signal S2, thereby controlling the electrical connections between the plurality of POE ports (e.g., the POE ports 100, 110 and 120) and the plurality of DC converter modules (e.g., the DC converter modules 500 and 510).

For example, as shown in FIG. 2, the controller 300 may determine two POE ports among the POE ports 100, 110 and 120 which are suitable for establishing electrical connection with the DC converter modules 500 according to the detection signal S1, and then control the switches 400, 410 and 420 through the control signal S2 so that the two POE port determined as suitable can transmit the input power thereof to the DC converter modules 500 and 510 respectively. Then, the power converted by the DC converter modules 500 and 510 can be provided to various powered devices for use after being integrated.

In some embodiments, each of the plurality of DC converter modules (e.g., the DC converter modules 500 and 510) may comprise a DC converter and a current sharing controller that are electrically connected with each other, and the plurality of DC converters are electrically connected with the plurality of switches (e.g., the switches 400, 410 and 420) so that the power converted by the DC converter modules 500 and 510 can be tuned into power suitable for being outputted to the powered devices under current sharing.

In some embodiments, if the controller 300 determines that none of the plurality of POE ports (e.g., the POE ports 100, 110 and 120) is suitable for establishing electrical connection with the DC converter module 500 according to the detection signal S1, then the controller 300 may also control the plurality of switches (e.g., the switches 400, 410 and 420) through the control signal S2 so that none of the plurality of POE ports (e.g., the POE ports 100, 110 and 120) is electrically connected with the DC converter modules 500 and 510, thereby stopping outputting power to the powered devices.

In some embodiments, when the detection signal S1 indicates that one of the plurality of POE ports (e.g., the POE ports 100, 110 and 120) being electrically connected with the DC converter module 500 is abnormal or the power input from one of the plurality of POE ports is abnormal, the controller 300 may also control the switches 400, 410 and 420 through the control signal S2 to enable another POE port among the plurality of POE ports which is not supplying power to be electrically connected with the corresponding DC converter module 500 instead of the abnormal POE port. Taking FIG. 2 as an example, it is assumed that the POE ports 100 and 110 were originally electrically connected with the DC converter modules 500 and 510 respectively (i.e., the POE ports 100 and 110 provide power to the powered device), but when the detection signal S1 indicates that the POE port 100 is abnormal, the controller 300 may control the switches 400 and 420 through the control signal S2 to interrupt the electrical connection between the POE port 100 and the DC converter module 500 and initiate the electrical connection between the POE port 120 and the DC converter module 500 so that the POE ports 110 and 120 supply power to the powered devices instead.

In some embodiments, the controller 300 may be further configured to regularly or irregularly change or switch the electrical connections between the plurality of POE ports (e.g., the POE ports 100, 110 and 120) and the DC converter modules 500 and 510 in order through the control signal S2. In a case of regular switching, the user may also upload the preset switching time and switching mode to the cloud through a UART, and the controller 300 may regularly turn on two of the switches 400, 410 and 420 in turn according to the preset switching time and switching mode, so that two of the POE ports 100, 110 and 120 regularly establish electrical connections with the DC converter modules 500 and 510 in turn. For example, the result of regular switching may be as follows: the POE ports 100, 110 are electrically connected with the DC converter modules 500, 510 respectively; after that, the POE ports 110, 120 are electrically connected with the DC converter modules 500, 510 respectively; and finally, the POE ports 120, 100 are electrically connected with the DC converter modules 500, 510 respectively. The result of regular switching as stated is not a limitation.

In some embodiments, the controller 300 may also be configured to regularly or irregularly change or switch the electrical connections between the plurality of POE ports (e.g., the POE ports 100, 110 and 120) and the DC converter modules 500 and 510 at random through the control signal S2. In a case of regular switching, the user may also upload the preset switching time and switching mode to the cloud through a UART, and the controller 300 may regularly turn on two of the switches 400, 410 and 420 at random according to the preset switching time and switching mode so that the POE ports 100, 110 and 120 can regularly establish electrical connections with the DC converter modules 500 and 510 at random. For example, the result of regular switching at random may be as follows: the POE ports 100, 110 are electrically connected with the DC converter modules 500, 510 respectively; after that, the POE ports 100, 120 are electrically connected with the DC converter modules 500, 510 respectively; next, the POE ports 110, 120 are electrically connected with the DC converter modules 500, 510 respectively; and finally, the POE ports 120, 100 are electrically connected with the DC converter modules 500, 510 respectively. The result of regular switching as stated is not a limitation. In addition, the preset switching mode of the controller 300 according to the present invention is not limited to switching two of the POE ports at the same time, but may also randomly switch any single one or more than two of the POE ports at the same time.

It shall be additionally noted that, since the POE switching device 10 according to the present invention can turn on and/or turn off any switch in the switch set 20 arbitrarily according to the demands of users by the controller 300, in other embodiments, the number of DC converter modules may also be greater than the number of switches in the switch set 20. For example, the switch set 20 including three switches may be used for four DC converter modules (not shown).

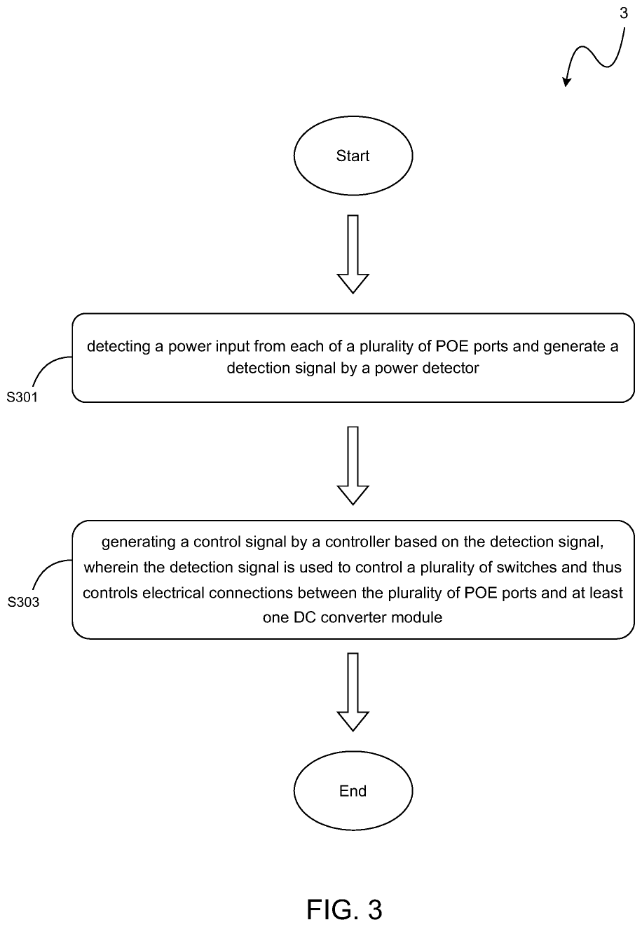

FIG. 3 illustrates a flowchart for describing a POE switching method according to some embodiments of the present invention. The content shown in FIG. 3 is provided only for the descriptions of the POE switching method and should not be regarded as any limitations to the present invention.

Referring to FIG. 3, a POE switching method 3 for a POE system (hereinafter referred to as “POE switching method 3”) may comprise the following steps: detecting a power input from each of a plurality of POE ports and generate a detection signal by a power detector (labeled as step S301); and generating a control signal by a controller based on the detection signal, wherein the detection signal is used to control a plurality of switches and thus controls electrical connections between the plurality of POE ports and at least one DC converter module (labeled as step S303), and wherein the plurality of switches are connected with the plurality of POE ports respectively and connected with the at least one DC converter module.

In some embodiments of the POE switching method 3, the detection signal is used to indicate an input status of each of the plurality of POE ports.

In some embodiments of the POE switching method 3, when the detection signal indicates that there is an abnormal POE port in ones of the plurality of POE ports that are electrically connected with the at least one DC converter module, the control signal enables another one of the plurality of POE ports to be electrically connected with the at least one DC converter module instead of the abnormal POE port.

In some embodiments, the POE switching method 3 further comprising: regularly or irregularly changing the electrical connections between the plurality of POE ports and the at least one DC converter module in order through the control signal by the controller.

In some embodiments, the POE switching method 3 further comprising: regularly or irregularly changing the electrical connections between the plurality of POE ports and the at least one DC converter module at random through the control signal by the controller.

Each embodiment of the POE switching method 3 basically corresponds to a certain embodiment of the POE switching device 10. Therefore, although not all of the embodiments of the POE switching method 3 are described in detail above, those of ordinary skill in the art can fully understand and implement all the corresponding embodiments of the POE switching method 3 simply with reference to the above description of the POE switching device 10.

The above embodiments are only examples for illustrating the present invention, and are not intended to limit the scope claimed in the present invention. Any other embodiments produced by modifying, changing, adjusting and integrating the above-mentioned embodiments shall all be included in the scope claimed in the present invention as long as they are not difficult for those of ordinary skill in the art to contemplate. The scope claimed in the present invention shall be governed by the claims.

What is claimed is:

1. A power over ethernet (POE) system, comprising:
a plurality of POE ports;
a power detector, being connected with the plurality of POE ports, and being configured to detect a power input from each of the plurality of POE ports and generate a detection signal;
a plurality of switches, being connected with the plurality of POE ports respectively;
at least one direct current (DC) converter module, being connected with the plurality of switches; and
a controller, being connected with the power detector and the plurality of switches, and being configured to generate a control signal based on the detection signal, wherein the control signal is used to control the plurality of switches and thus controls electrical connections between the plurality of POE ports and the at least one DC converter module.

2. The POE system of claim 1, wherein the detection signal is used to indicate an input status of each of the POE ports.

3. The POE system of claim 1, wherein when the POE system comprises a plurality of DC converter modules, each of the plurality of DC converter modules includes a DC converter and a current sharing controller that are electrically connected with each other, and the plurality of DC converters are electrically connected with the plurality of switches respectively.

4. The POE system of claim 1, wherein when the detection signal indicates that there is an abnormal POE port in ones of the plurality of POE ports that are electrically connected with the at least one DC converter module, the control signal enables another one of the plurality of POE ports to be electrically connected with the at least one DC converter module instead of the abnormal POE port.

5. The POE system of claim 1, wherein the controller is further configured to regularly or irregularly change the electrical connections between the plurality of POE ports and the at least one DC converter module in order through the control signal.

6. The POE system of claim 1, wherein the controller is further configured to regularly or irregularly change the electrical connections between the plurality of POE ports and the at least one DC converter module at random through the control signal.

7. A power over ethernet (POE) switching device for a POE system, comprising:
a power detector, being connected with a plurality of POE ports, and being configured to detect a power input from each of the plurality of POE ports and generate a detection signal;
a plurality of switches, being connected with the plurality of POE ports respectively and connected with at least one direct current (DC) converter module; and
a controller, being connected with the power detector and the plurality of switches, and being configured to generate a control signal based on the detection signal, wherein the control signal is used to control the plurality of switches and thus controls electrical connections between the plurality of POE ports and the at least one DC converter module.

8. The POE switching device of claim 7, wherein the detection signal is used to indicate an input status of each of the POE ports.

9. The POE switching device of claim 7, wherein when the detection signal indicates that there is an abnormal POE port in ones of the plurality of POE ports that are electrically connected with the at least one DC converter module, the control signal enables another one of the plurality of POE ports to be electrically connected with the at least one DC converter module instead of the abnormal POE port.

10. The POE switching device of claim 7, wherein the controller is further configured to regularly or irregularly change the electrical connections between the plurality of POE ports and the at least one DC converter module in order through the control signal.

11. The POE switching device of claim 7, wherein the controller is further configured to regularly or irregularly change the electrical connections between the plurality of POE ports and the at least one DC converter module at random through the control signal.

12. A power over ethernet (POE) switching method for a POE system, comprising:
detecting a power input from each of the plurality of POE ports and generate a detection signal by a power detector; and
generating a control signal by a controller based on the detection signal, wherein the control signal is used to control a plurality of switches and thus controls electrical connections between the plurality of POE ports and at least one direct current (DC) converter module, and wherein the plurality of switches are connected with the plurality of POE ports respectively and connected with the at least one DC converter module.

13. The POE switching method of claim 12, wherein the detection signal is used to indicate an input status of each of the POE ports.

14. The POE switching method of claim 12, wherein when the detection signal indicates that there is an abnormal POE port in ones of the plurality of POE ports that are electrically connected with the at least one DC converter module, the control signal enables another one of the plurality of POE ports to be electrically connected with the at least one DC converter module instead of the abnormal POE port.

15. The POE switching method of claim 12, further comprising: regularly or irregularly changing the electrical connections between the plurality of POE ports and the at least one DC converter module in order through the control signal by the controller.

16. The POE switching method of claim 12, further comprising: regularly or irregularly changing the electrical connections between the plurality of POE ports and the at least one DC converter module at random through the control signal by the controller.
